(19) United States
(12) Patent Application Publication
(10) Pub. No.: US 2010/0062712 A1
(43) Pub. Date: Mar. 11, 2010

(54) CUSTOMIZED BLUETOOTH ENABLED IDENTIFICATION DEVICE

(76) Inventor: BALAJI LAKSHMANAN, CHENNAI (IN)

Correspondence Address: BALAJI LAKSHMANAN, 52D, Srichakra Apts, 47th Street, Ashok Nagar, CHENNAI, TAMIL NADU, 600083, omitted

(21) Appl. No.: 12/554,885

(22) Filed: Sep. 5, 2009

Related U.S. Application Data
(60) Provisional application No. 61/094,877, filed on Sep. 6, 2008.

(51) Int. Cl. H04B 7/00

(52) U.S. Cl. 455/41.2

(57) ABSTRACT

A customized Bluetooth enabled identification device for Bluetooth based identification, communication and tracking system is described. The device uses a customized Bluetooth hardware as identification of location is done through its 48 bit unique hardware address by providing password based security over identification.

### FIELD OF THE INVENTION

The field of the invention relates generally to wireless communication devices whose functions may be controlled by a local wireless system such as a Bluetooth wireless network and more particularly, to a device that can communicate wirelessly with a Bluetooth wireless network which uses a Bluetooth enabled identification device as identification through its 48 bit unique hardware address providing password based security over identification.

### BACKGROUND

Security is one of the most crucial requirements for any company; it is extremely difficult for security agencies to check the identity without causing inconvenience to them. It is harder if such security identification checks need to be performed a number of times. The need of the hour is a security system which is automated, requires little human intervention, less time for verification and which cannot be faked easily. And similarly it known that the BLUETOOTH is an emerging wireless standard, operating in the 2.4 GHz ISM band world-wide according to existing specifications known in the art and publicly available.

Although originally developed for use in the mobile phone industry, widespread adoption within the consumer electronics industry suggests that it is likely to become a popular and commonplace home wireless standard in the coming years. Due to its predicted penetration into the consumer market, it is of considerable interest to use the BLUETOOTH standard as the bearer for a cordless telephone system. The advantages of Bluetooth are that it is wireless, has a unique hardware address for each Bluetooth device, has security in a password or pin number to check authenticity, enables two way communication, available in different ranges of 1 meter, 10 meter, 100 meters, etc, low power consumption, less interference of noise and can be turned on when required and off when not required.

Most of the current mobiles are Bluetooth enabled. Mobile is the only device which most people want to carry all the time. Accordingly, what is needed is a method for determining location of a mobile unit inside buildings, shopping malls or underground, etc.

The relevant prior art methods, which will deal with mobile phone which uses a Bluetooth for the identification of the location are as follows:

U.S. Pat. No. 7,260,835 explains a Bluetooth based security system utilized to provide ad-hoc security services to secured assets. Such a Bluetooth based security system comprises a secured device (SD) equipped with Bluetooth (BT) technology; a plurality of Bluetooth Access Points (BTAPs) located at designated points to establish a BT link with the secured device (SD); and a security server (SS) connected to all BTAPs and arranged to provide access control and security services for the secured device (SD), wherein the security server (SS) obtains attribute information of the secured device (SD), including an unique device identification (ID) and a last known location of the secured device (SD), activates a lock with the secured device (SD), and sends location information of a designated BTAP and an unlock code to the secured device (SD), via the designated BTAP.

U.S. Pat. No. 6,760,581 reveals a system and method for providing a hold operation from a mobile telephone. When a call is received and the mobile telephone user cannot readily answer the phone, he presses a “hold” key on the mobile telephone. The hold key plays a message to the caller informing the caller that the receiver intends to answer the call momentarily. In this manner, calls received in places where mobile telephone calls are discouraged or prohibited can be placed on hold until the receiver has moved to a location where he can answer the call. For example, in a theater incoming calls can be held so the user can move to a hallway where he can answer the call and talk to the caller. Wireless technology (Bluetooth) is used to automatically hold calls when the mobile telephone receives a command from a server that installed in the theater or other public place.

U.S. Pat. No. 6,297,737 describes about a locating unit includes a wireless communications interface for transmitting signals to one or more locating tags. A user physically associates each tag with an item of interest, such as a briefcase or key ring. When a tagged item is misplaced, the user uses the locating unit to find it. Using the user interface included in the locating unit, the user selects the desired item from a listing of tagged items. Based on the user selection, the locating unit polls the associated tag. The polled tag responds by emitting an audible signal, thereby aiding the user in determining its location. Preferably, the locating unit is a mobile terminal and communications between the mobile terminal and individual tags is two-way. Thus, a polled tag returns a found signal to the mobile terminal in response to being polled. The mobile terminal provides the user with found/not-found indication, from which the user can ascertain whether the desired tagged item is within range of the polling signal, even if the tag's audible signal cannot be heard. Tags preferably include a switch that, when actuated, causes the tag to poll the mobile terminal. In response to receiving a poll signal from a tag, the mobile terminal emits an audible signal and returns a found signal to the polling tag. The polling tag provides the user with a found/not-found indicator. Thus, individual tags can be used to locate the mobile terminal. Preferably, the wireless interfaces in the mobile terminal and locating tags are Bluetooth transceivers.

US Patent Application No. 20050287958 claims a connecting device for wireless communication. The said connecting device is primarily installed in a mobile phone to enable transmission and reception of message between both sides for communicating, in which the said connecting device utilizes the connecting technology of the Bluetooth or the public channel to enable end-to-end connection or multipoint connection, and thereby to enable transmission and reception of message. It also allows allocating an independent base station on a car or at a fix location for receiving and transferring message to relax the distance constraint of wireless communication and to support the function of hands-free.

US Patent Application No. 20070088812 discloses a media control computer system that provides centralized access and distribution of digital media content. The system provides a user full control of multiple media sources from any television or video screen connected to the system. The system provides for storage and distribution of various types of media in practically any digital format, such as movies, television programs, music and video games. The system may be controlled wirelessly, such as using Bluetooth technology. The system may be expanded using expansion cards or chips that a user may install in one central location, thereby replacing the many “black boxes” of the typical home entertainment center. The system receives input from the Internet, cable/satellite television, peripheral devices and various types of media devices. Media output may be distributed to television screens and audio systems throughout a home, office or other location.

US Patent Application No. 20080074488 brings out a method (100) or system (600) of controlling audible alerts includes detecting (102) a communication event among participant devices (204 and 206), detecting (104) a non-participant device (208, 210 or 212) within a predetermined range of a participant device, and sending (106) a wireless control signal by at least one among the participant devices to the non-participant device to control audible alert functions. The wireless control signal can be sent (108) after a start of the communication event and can be sent (110) for example using Bluetooth signaling, signaling using an IEEE 802.11 standard, or any other signaling. The method can mute (112) audible alerts on the non-participant device in response to receipt of the wireless control signal. Detecting the communication event can include detection of an instant messaging session, a telephone conference, a video conference, a audio-visual conference, internet or online or web conferencing, or a calendared event.

Any person in general enters his organization through a main entry point where in general there is either less or no security verification. This happens especially if he comes in car. Here in general people are checked for their identity card (which, in most cases can be faked), It also takes more time if there are more people and sometimes not exhaustive, there are good chances to trespass without being checked. Everyone should have to take out their identity card and show to the security personnel. Even if he/she is to be checked, it is very hard for the security personal to stop the car, verify the identity and let him proceed further, It is also very hard for the security to passes some information to a particular person or group of people. it is also very inconvenient for anyone who is entering the organization. There are good chances that such verification is not performed or is detected late resulting in huge security lapse. Hence, the need is to identity people without causing inconvenience, without delay and helps the security personnel to selectively identify someone or group to detain or pass some information.

However the purpose and methodology of the above inventions that are part of prior art do not envisage the security verification that to be performed wirelessly without any interruption to the persons. They also do not provide the steps and tools to go about the same. Most of the patents shown are not a personal identification device, do not possess customized hardware, do not have password based control or security features, and do not envisage a two way communication level device. Most of them use bluetooth as a communication medium which involves scanning for the device, detecting the device and send/receive information. Most of the above patents contemplate only a location based service provider.

Further limitations and disadvantages of conventional and traditional approaches presented in the above prior art will become apparent to one of skill in the art, through comparison of such systems with some aspects of the present invention as set forth in the remainder of the present application with reference to the drawings.

The present invention differs from the existent prior art in that it uses a customized Bluetooth enabled device or a method, apparatus and system for Bluetooth based identification, communication and tracking system is described. The present invention further provides security verification to be performed wirelessly and confirmation of identity using password or pin number and all the particulars and information of the Bluetooth holder will be generated at the security desk for verification by using the Bluetooth identify.

It will be apparent to those skilled in the art that the objects of this invention have been achieved by providing service branding framework which is unique in nature of service businesses unlike existing positioning models that are suited only for products. Various changes may be made in and without departing from the concept of the invention. Further, features of some stages disclosed in this application may be employed with features of other stages. Therefore, the scope of the invention is to be determined by the terminology of the following description, claims, drawings and the legal equivalents thereof.

### SUMMARY OF THE INVENTION

This invention may be summarized, at least in part, with reference to its objects. The primary object of this invention is to use a customized Bluetooth enabled hardware device which provide password based security over identification of the Bluetooth device in its zone by a unit called Bluetooth device detection system.

Therefore it is the an object of the present invention to provide Bluetooth enabled identification device which uses this Bluetooth based identification for various applications, communication, tracking etc.

It is another object of the present invention to provide Bluetooth enabled identification device detection system which actually detects the name of the Bluetooth device (mobile phone) and the 48 bit hardware address.

It is another object of the present invention to provide security verification to be performed wirelessly and confirmation of identity using password or pin number and all the particulars and information of the Bluetooth holder to be generated at the security desk for verification by using the Bluetooth enabled identification device.

It is yet another object of the present invention to use the Bluetooth enabled identification device, by which the approximate location of the Bluetooth device in a given area can be estimated and tracked.

It is yet another object of the present invention to use the Bluetooth enabled identification device for sending message and data to individual or group automatically through secure communication which can be used for synchronization of a group.

It is another object of the present invention to use the Bluetooth enabled identification device by which the verification is done and automatically logged in. These and other objects of the present invention will be more readily apparent when considered in reference to the following description and when taken in conjunction with the accompanying drawings.

### DESCRIPTION OF THE INVENTION

The following description is presented to enable any person skilled in the art to make and use the invention, and is provided in the context of particular applications of the invention and their requirements. The present invention can be configured as follows:

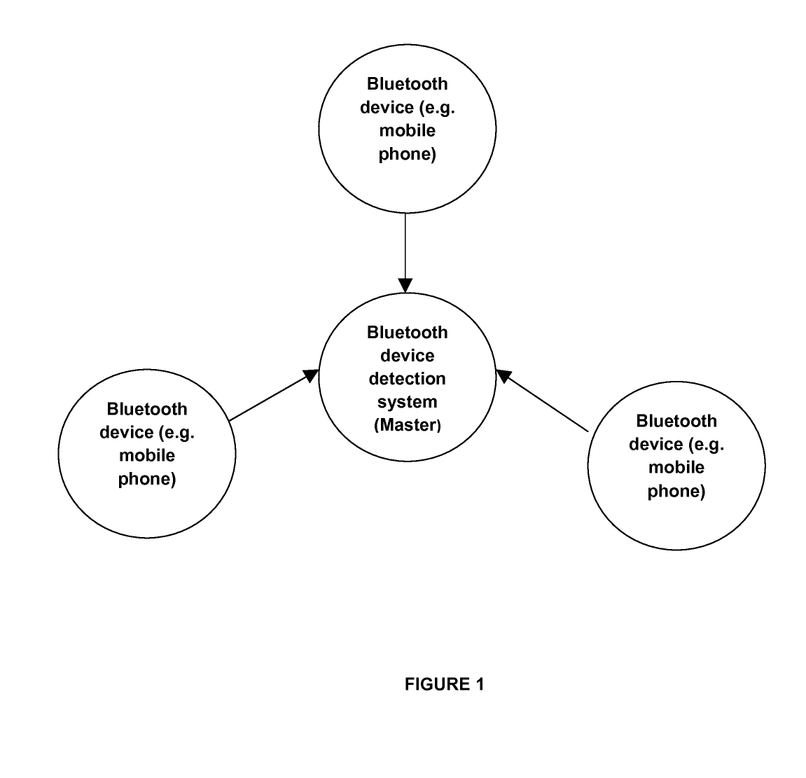

FIG. 1 is a flow diagram that illustrates a Bluetooth device detection system by which Bluetooth devices are identified.

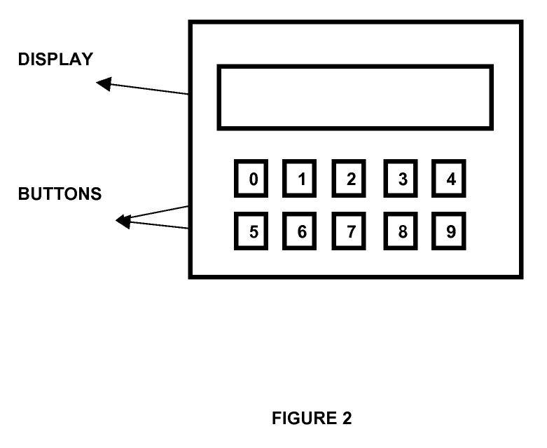

FIG. 2 is a box diagram that illustrates the parts of the Bluetooth enabled identification device.

Customized Bluetooth hardware is specially developed to create a Bluetooth enabled identification device deal with the identification, communication and tracking system for the approximate location of the Bluetooth device. As detailed in FIG. 2, the bluetooth enabled identification device is a compact device which has a display and a number of buttons. Display is used to display the message from the master/other Bluetooth devices. It is used to display the instructions/directions or display the keys/buttons pressed. The keys/buttons have digits and alphabets. It is used to enter password when required or type message to be sent.

For each Bluetooth enabled identification device the following shall be first set up:
Computer Pentium III or equivalent
Operating system-Debian 4.0
Bluetooth stack packages
Bluetooth dongle.

The device is operated by using customized Bluetooth hardware as detailed in FIG. 1. The Bluetooth enabled identification device is used as identification through its 48 bit unique hardware address. Password based security is provided over identification. All the Bluetooth devices which are used for identification are registered once with the Bluetooth device detection system. The computer system detects the Bluetooth dongle and is ready for identifying the Bluetooth devices in its zone. The system listens for the packets or message from any Bluetooth device in its zone. Any individual who is in the zone should turn ON the Bluetooth in his mobile phone. The 48 bit hardware address and name of the Bluetooth device (mobile phone) is detected by the Bluetooth device detection system. The identity of the person is verified with the 48 bit hardware address. If the password based verification is required, the master sends request for connection to the Bluetooth device (mobile phone). Using secure password the connections is established. Password based identity verification over Bluetooth is achieved. The master then closes the connection.

Hence the embodiment of the present invention named Bluetooth enabled identification device can be effectively used in this scenario where every person entering is uniquely identified and details of the person along with photograph will be available for the security. And information can be passed to anyone or everyone securely without stopping them. Bluetooth identify will be ideal to Wirelessly grant access with no human intervention and no any inconvenience is caused.

Another embodiment of the Bluetooth identify can be used for identifying if the correct person is logging into the system and it automatically locks the system if the person moves away. Optionally, it can also help the managers and security to check if the person is near the computer and possibly working. And Bluetooth identify can be also as automatic attendance marking system, where individuals need not go near access card/smart card reader or stand in big line for marking attendance.

Another embodiment of the present invention can find the zone of presence of a person/object based on the Bluetooth device and using localization technique we could come up with approximate location of the person/object. Localization is achieved using the signal strength of the Bluetooth device. The approximate location of the blue device in a given area can be estimated.

Another embodiment of the present invention facilitates Secure, Selective message/data passing and synchronization where by the message and data can be send to individual or group automatically when they are detected in range. Thus a message/data to individual or group automatically when they are detected in range and can be used for synchronization of a group. This results in secure two way communication and with acknowledgement and which can be documented. No external service is required.

Another embodiment of the present invention facilitates tracking, whereby we can find the zone of presence of a person/object based on his Bluetooth device and using localization technique we could come up with approximate location of the person/object. Localization is achieved using the signal strength of the Bluetooth device. The approximate location of the blue device in a given area can be estimated. In general it is hard to track where a particular person/object is present currently. Identity cards based tracking can be done only if swiped and give the last point of entry/exist.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. Customized Bluetooth enabled identification device for Bluetooth based identification, communication and tracking system comprising of a customized Bluetooth hardware for identifying the approximate location (x,y) of the Bluetooth device wherein the identification is done through a 48 bit unique hardware address and by providing password based security over identification.

2. Customized Bluetooth enabled identification device as claimed in claim 1 wherein the said invention consists of an external system of a computer comprising of Pentium III or equivalent, an operating system comprising of Debian 4.0, bluetooth stack packages and a bluetooth dongle.

3. Customized Bluetooth enabled identification device as claimed in claim 1 wherein the said invention has a compact display to display the message from the master/other Bluetooth devices and instructions/directions or display the keys/buttons pressed.

4. Customized Bluetooth enabled identification device as claimed in claim 1 wherein the said invention has keys/buttons containing digits and alphabets and used to enter password when required or type message to be sent.

5. Customized Bluetooth enabled identification device as claimed in claim 1 wherein all the Bluetooth devices which are used for identification are registered once with the said invention

6. Customized Bluetooth enabled identification device as claimed in claim 1 wherein the said computer system detects the said Bluetooth dongle and is ready for identifying the said bluetooth devices in its zone.

7. Customized Bluetooth enabled identification device as claimed in claim 1 wherein the said computer system listens for the packets or message from any of the said Bluetooth devices in its zone that are turned on thus enabling the Bluetooth in the device.

8. Customized Bluetooth enabled identification device as claimed in claim 1 wherein the said invention detects the 48 bit hardware address and name of the said Bluetooth device and the identity of the person is verified.

9. Customized Bluetooth enabled identification device as claimed in claim 1 wherein the master sends request for connection to the said Bluetooth device if password based verification is required.

10. Customized Bluetooth enabled identification device as claimed in claim 1 and claim 9 wherein the said connection is established using secure password, password based identity verification is achieved and the connection is closed.

11. Customized Bluetooth enabled identification device as claimed in claim 1 wherein the said invention provides for security verification to be performed wirelessly and confirmation of identity using password or pin number.

12. Customized Bluetooth enabled identification device as claimed in claim 1 wherein the said invention indicates the approximate location (x,y) of the Bluetooth device in a given area by estimating the signal strength of the bluetooth device and tracking it.

13. Customized Bluetooth enabled identification device as claimed in claim 1 wherein the said invention provides for sending message and data to individual for synchronization of group whereby an application be developed and automatically logged in.
